(19) United States
(12) Patent Application Publication
(10) Pub. No.: US 2012/0158609 A1
(43) Pub. Date: Jun. 21, 2012

(54) Method to Manage Rail & Intermodal Fuel for Shippers

(76) Inventors: Craig S. Dickman, Green Bay, WI (US); Douglas J. Mueller, Green Bay, WI (US)

(21) Appl. No.: 13/333,819

(22) Filed: Dec. 21, 2011

Related U.S. Application Data
(60) Provisional application No. 61/425,291, filed on Dec. 21, 2010.

(51) Int. Cl. G06Q 50/28

(52) U.S. Cl. 705/335

(57) ABSTRACT

A process for managing intermodal fuel costs. The process entails receiving, compiling, and storing transaction information at a Network Administrator. The transaction information is associated with at least one shipper who has arranged for an intermodal shipment of goods from an origin to a destination; and at least one carrier that has agreed to complete at least one leg of the intermodal shipment. The transaction information includes the mode of transportation, the distance traveled, the pick-up and drop-off locations, and the contemporaneous market cost of fuel, for each leg of the shipment. This information is transmitted from the Network Administrator to the shipper. The information is used by the shipper to calculate an appropriate fuel payment to each carrier on each leg of the intermodal shipment.

### CROSS-REFERENCE TO RELATED APPLICATIONS

Priority is hereby claimed to provisional application Ser. No. 61/425,291, filed Dec. 21, 2010, which is incorporated herein.

This application is related to U.S. Pat. No. 7,729,998, issued Jun. 1, 2010, to Craig S. Dickman.

### BACKGROUND

The economic impact of high fuel costs for shippers is significant. In 2004, the fuel bill for the U.S. trucking industry (collectively referred to as “carriers”) was greater than $90 billion. In the immediately preceding year, 2003, the fuel bill for carriers was $76 billion. See Transport Topics, Jun. 17, 2005, print edition, “Trucking Fuel Tab Soars,” (Transport Topics Publishing Group, Alexandria, Va.). That is a one-year cost increase of greater than 18%. The long-term trend is clearly pointing in the direction of ever-increasing fuel prices. With extreme and continuing political instability in oil-producing countries (such as Nigeria, Venezuela, Libya, Iran, and Iraq), continuing military operations in Iraq, and political opposition to building pipeline from Canada to the U.S. and opposition to drilling in known reserves on U.S. soil (such as in the Arctic National Wildlife Refuge), fuel prices are likely to continue to rise.

Political instability in oil-producing regions and hurricanes impacting U.S. ports on the Gulf of Mexico also contribute mightily to short-term volatility in fuel prices. Hurricane Katrina (which made land fall on the gulf coast of the United States on Aug. 29, 2005) caused an immediate and severe spike in fuel prices at the pump. Managing such price volatility (to the extent possible) is critical for the efficient movement of goods to market. In short, bottom-line profit margin for shippers (i.e., the margin of companies moving their goods to market, as opposed to the profit margin of the trucking companies themselves) is inversely proportional, dollar-for-dollar, to shipping costs. In an efficient marketplace, the actual cost of shipping should be closely related to fuel costs. In other words, every dollar saved on fuel costs should be a dollar that goes to the bottom line of the shipper (not the carrier). However, that is not the current situation.

In the United States, common freight carriers (companies such Federal Express, UPS, DHL, etc.), truckload segment carriers (companies such as Schneider, Swift, J.B. Hunt, etc.) and a huge number of other local, regional, national, and international carriers) manage the fluctuating cost of fuel by assessing a “fuel surcharge.” Airlines (both passenger and cargo lines) likewise assess fuel surcharges. The surcharge is based upon a formula that uses the average retail cost of fuel (the average cost of diesel for ground carriers; the average cost of jet fuel for air carriers) for a preceding period of time and multiplies it by a sliding scale to arrive at a fuel surcharge that is added to actual cost to ship the goods from the origin to the destination. (The scale can be based on, for example, a percentage of the fuel cost, or per mile traveled, etc.) As a general rule, every surcharge protocol currently in use is based on the average, full retail price of fuel. But the carriers' actual cost for fuel is significantly less because the carriers receive volume discounts for large fuel purchases. Thus, at the time the cost for a shipment is estimated, the carrier provides the estimate based upon the current actual cost, plus the current fuel surcharge. The surcharge functions to inflate the cost of fuel, thereby guaranteeing the carrier a profit (or, at an absolute minimum, preventing the carrier a loss). In essence, by using a sliding scale based on historical and average fuel costs, the surcharge increases the carriers' revenue based upon the actual amount the carrier paid for fuel. The fuel price spread (that is, the fuel surcharge levied by carriers as compared to the carriers' true cost for the fuel) is a major flaw that financially harms shippers. In short, in the event a carrier's actual fuel costs are higher at the time a shipment is made, the surcharge limits the carrier's costs by assessing the shipper an addition fee in excess of the actual cost the carrier paid for the fuel.

The fuel surcharge arrangement, while not calculated in the same fashion from carrier to carrier, has been implemented industry-wide. All of the surcharge protocols follow the same basic approach: a sliding scale is compiled linking the historic cost of fuel to a multiplier. The fuel surcharge is, quite literally, wholly disconnected from the actual price a carrier pays for the fuel required to complete any given shipment. It is simply a charge based upon the national average, full retail, at-the-pump cost for fuel during some pre-set time period preceeding the date when the shipment is made. As a result, the fuel surcharge system produces both a cost inflation to shippers (because carriers generally do not pay full retail prices for fuel) and a time distortion (because the surcharge is based on historic average fuel costs, rather than contemporaneous fuel costs at the time the shipment is made). In practice, the amount of fuel required to complete any given movement is computed using the distance in miles between the origin and the destination, multiplied by an agreed upon miles-per-gallon for the vehicle(s) used to transport the freight. For example, in calculating the surcharge for diesel fuel, DHL (a domestic and international carrier) currently utilizes an indexed fuel surcharge based upon the fuel prices published by the U.S. Department of Energy. DHL's diesel fuel surcharge calculation is based upon the spot price for diesel fuel.

For jet fuel, however, DHL uses a different calculation to determine the “appropriate” fuel surcharge. DHL's air shipment fuel surcharge is linked to the monthly rounded average of the U.S. Gulf Coast (USGC) price for a gallon of kerosene-type jet fuel, as published by the U.S. Department of Energy. DHL currently applies the monthly rounded average from the period two months prior to calculate the applicable fuel surcharge percentage

In contrast, UPS (another domestic and international common carrier) uses an index-based surcharge for diesel fuel. UPS's surcharge scale is adjusted monthly. In the current arrangement, changes to the surcharge schedule are effective the first Monday of each month and posted approximately two weeks prior to the effective date. UPS calculates its fuel surcharge based on the National U.S. Average On-Highway Diesel Fuel Prices reported by the U.S. Department of Energy for the month that is two months prior to the adjustment. Thus, for example the surcharge for March 2006 is based on the January 2006 National U.S. Average On-Highway Diesel Fuel Price. UPS uses an analogous schedule for air freight, the air freight surcharge schedule being linked the USGC price for kerosene-type jet fuel.

A host of other methods of calculating the surcharge are known. For example, Schneider National (Green Bay, Wis.; currently the largest truckload carrier in North America) bases its surcharge on the Average On-Highway Diesel Prices, adjusted weekly. Thus, for the first week in March 2006, Schneider's fuel surcharge was based on the then-average on-highway price for diesel, $2.545 per gallon. Using the then-standard base cost for fuel ($1.20 per gallon, the cost factored into the charge for the movement itself) yields a differential of $1.345 per gallon in the first week of March 2006. This value is then divided by 5 mpg (the estimated average mileage of Schneider's trucks) to arrive at a surcharge of $0.269/mile. Thus, for a shipment of 1,500 miles, taking place in early March 2006, Schneider National would have levied a fuel surcharge of $403.50.

Literally all US common carriers reserve the right to change their fuel surcharge percentages and thresholds without prior notice. The result is that the fuel costs paid by shippers are not controlled by the shippers. Instead, fuel costs are set by historical rates and the surcharge percentages and price thresholds established (unilaterally) by carriers. As matters presently stand, shippers (for whose benefit the fuel is purchased and consumed) have no control over the cost at which that fuel is purchased. Likewise, shippers have no control over where and when that fuel is purchased. Shippers are therefore paying more than they should to move their goods to market.

Like many businesses, common carriers and shippers alike, are increasing using the internet and other network arrangements, to wring greater efficiencies from their operations. The continued growth of the internet, and the continued growth in commerce transacted over the internet, has thus witnessed a corresponding rise in the number of patents addressing methods for conducting commerce via a computer interface. Many of these patents touch on methods for managing fuel costs or for hedging the future cost of fuel (and other commodities). For example, U.S. Pat. Nos. 6,885,996; 6,375,539; and 6,332,128, all to G. R. Nicholson, describe a process for granting price-per-unit discounts on fuel costs. The fuel price discount is linked to the buyer purchasing other, cross-marketed items from the same vendor or from a different vendor.

U.S. Pat. No. 6,965,872, to Grdina, describes a subscription-based service wherein a consumer can purchase fuel in advance, at an agreed upon price, and the seller must deliver the fuel at the agreed upon price. In essence, the system is a debit card arrangement for hedging the purchase price of fuel.

U.S. Pat. No. 6,249,772, to Walker et al., and assigned to Walker Digital, LLC, describes the process behind the “name-your-price” web auctioneer Priceline.com. In this pricing protocol, there is a middleman (the “central controller” in the terms used by the patent) who links buyers and sellers in a double-blind fashion. The buyer is unaware of the seller's asking price, and the seller is unaware of the buyer's offering price. The asking price and the offering price are matched by the “central controller.” If the buyer's offered price is higher than the seller's asking price, the sale is consummated, and the difference is pocketed as revenue by the “central controller,” i.e., Priceline. But if the buyer's offered price is too low, the sale is not consummated. In either instance, the buyer is never informed of the seller's actual asking price, and vice-versa. The “central controller” makes the decision on whether to make the sale or not, without transmitting the asking price to the buyer, or transmitting the offered price to the seller.

There are many other internet commerce selling protocols described in the recent U.S. patent literature. To get a flavor of the overall increase in internet-based commerce, see, for example, U.S. Pat. Nos. 6,999,949; 6,970,837; 6,901,376; 6,868,394; 6,868,393; 6,839,683; 6,754,636; 6,745,190; 6,587,827; 6,016,504; 5,966,697; and 5,970,474. See also U.S. Publication Nos. 2001/0037512; 2002/0116318; and 2006/0036448.

### SUMMARY

The present process is based on: (1) one unassailable fact; and (2) a fundamental shift in managing the cost of fuel. The unassailable fact is that shippers (not carriers) ultimately pay for high fuel costs. But in the current system, shippers have absolutely no control over the cost they pay for fuel. In the current system of fuel surcharges, the carrier chooses where to purchase the fuel, the carrier chooses when to purchase the fuel, the carrier chooses how much to pay for the fuel, and the carrier chooses the fuel surcharge assessed to the shipper. In each step of the current arrangement between shippers and carriers, the shipper, who ultimately pays both the actual cost of the fuel and the fuel surcharge, has absolutely no input on managing this critical element of the cost of production. In short, the current system is inefficient because the control and management of fuel acquisition and distribution is placed in the hands of the sellers (i.e., the carriers companies) rather than the buyers (i.e., the producers shipping their goods to market).

Thus, one version of the process is a computer-implemented method for managing intermodal fuel costs. The process comprises receiving, compiling, and storing transaction information at a Network Administrator loaded on a computer, the transaction information being associated with: at least one shipper who has arranged for an intermodal shipment of goods from an origin to a destination; and at least one carrier that has agreed to complete at least one leg of the intermodal shipment. The transaction information preferably comprises:
the mode of transportation for each leg of the shipment;
the distance traveled for each leg of the shipment;
the pick-up and drop-off locations for each leg of the shipment; and
the contemporaneous market cost of fuel for each leg of the shipment at or near the pick-up or drop-off locations.

The transaction information is transmitted from the Network Administrator to the shipper. The fuel payment to the carrier is then calculated based not upon an arbitrary fuel surcharge scheme, but upon the transaction information transmitted to the Network Administrator and provided to the shipper.

In the preferred version of the process, the transaction information is transmitted on a non-confidential basis to all shippers having access to the Network Administrator. This promotes transparency in the fuel market, and competition among carrier on terms other than the cost of fuel.

In other version of the process, the transaction information may further comprise:
the type of fuel required for each leg of the shipment (diesel, jet fuel, etc.);
the fuel efficiency of each vehicle used in each leg of the shipment; and
the location where fuel for each leg of the shipment was acquired.
   Again, it is preferred that all of this transaction information is provided on a non-confidential basis to all shippers having access to the Network Administrator.

In yet another version of the process, carrier fuel purchase information comprising actual price paid for fuel and amount of fuel purchased by the at least one carrier to complete each leg of the intermodal shipment is transmitted to the computer on which the Network Administrator is loaded. The carrier fuel purchase information may optionally further comprise one or more identifiers selected from the group consisting of a shipper identifier, a carrier identifier, a shipment identifier, an origin identifier, a destination identifier, a route identifier, a sender identifier, a recipient identifier, a date identifier, a time identifier, a location identifier, a fuel merchant identifier, a driver identifier, a vehicle identifier, a vehicle miles-per-gallon identifier, a vehicle odometer identifier, and a vehicle weight identifier. The carrier fuel purchase information optionally be transmitted from the computer on which the Network Administrator is loaded to the shipper and the carrier.

In addition to the criteria recited earlier, the transaction information may further comprise one or more identifiers selected from the group consisting of a shipper identifier, a carrier identifier, a shipment identifier, a shipment weight identifier, a pick-up date identifier, a delivery-date identifier, an origin identifier, a destination identifier, a route identifier, a sender identifier, a recipient identifier, a date identifier, a time identifier, a location identifier, a fuel merchant identifier, a driver identifier, a vehicle identifier, a vehicle miles-per-gallon identifier, a vehicle odometer identifier, a vehicle hours identifier, and a vehicle weight identifier.

In another version of the process, the transaction information further includes total volume of fuel purchased by the at least one shipper over a pre-determined prior time period, for example during the previous quarter or the previous 12 months. Calculating the fuel payment then includes discounting the fuel payment by an amount determined according to a pre-determined schedule corresponding to the total volume of fuel purchased by the at least one shipper over the pre-determined time period. For example, the fuel payment made by the carrier could be discounted by a sliding price percentage after the carrier had purchased a pre-determined amount of fuel (e.g., 500,000 gallons of diesel). This is just an example. The discount can be determined by any mutually agreeable and market acceptable method.

The process includes a medium storing instructions adapted to be executed by a processor to perform the method for managing fuel costs as described herein.

Numerical ranges as used herein are intended to include every number and subset of numbers contained within that range, whether specifically disclosed or not. Further, these numerical ranges should be construed as providing support for a claim directed to any number or subset of numbers in that range. For example, a disclosure of from 1 to 10 should be construed as supporting a range of from 2 to 8, from 3 to 7, 5, 6, from 1 to 9, from 3.6 to 4.6, from 3.5 to 9.9, and so forth.

All references to singular characteristics or limitations of the present process shall include the corresponding plural characteristic or limitation, and vice-versa, unless otherwise specified or clearly implied to the contrary by the context in which the reference is made.

All combinations of method or process steps as used herein can be performed in any order, unless otherwise specified or clearly implied to the contrary by the context in which the referenced combination is made.

The methods of the present process can comprise, consist of, or consist essentially of the essential elements, limitations, and/or of the method described herein, as well as any additional or optional components, steps, or limitations described herein or otherwise useful.

### BRIEF DESCRIPTION OF THE FIGURES

FIG. 1 is a flow chart depicting one version of the present process.

FIG. 2 is a map and associated distance and fuel surcharge information for an exemplary conventional shipment of freight from Aurora, Ill., to Hazlet, Tex. on Jun. 24, 2010.

FIGS. 3A, 3B, and 3C are maps and associated distances and charges for the same shipment as depicted in FIG. 2, using the present intermodal fuel cost process. FIG. 3A: dray by truck from Aurora, Ill. to Chicago, Ill. rail terminal; FIG. 3B rail shipment from Chicago to Hazlet, Tex. rail yard; FIG. 3C: dray by truck to final destination in Hazlet.

### DETAILED DESCRIPTION OF THE PROCESS

The following terms are explicitly defined as follows. All other terms not given an explicit meaning herein are to be given their conventional and accepted definition in the transportation industry.

The terms “carrier” or “common carrier” are synonymous and refer to a transporter (i.e., a company or an individual) that holds itself out to the general public for the transportation of goods over a definite route and according to a regular schedule. Thus, a “carrier” is any company or individual who transports the goods of another for a fee. The term “carrier” explicitly encompasses, without limitation, transporters moving goods by any means (land-based vehicles, water-based vehicle, aircraft, and spacecraft, all without limitation), and through any terrain (land, water, air, space). “Carrier” includes, without limitation, local, regional, national, and international transporters. (The term “common carrier” is something of a holdover from the common law. At common law, a common carrier is held liable for all losses that may occur to property entrusted to his charge during the act of storage or transport.)

The term “fuel” denotes, without limitation, any fuel, fuel additive, or fuel adjunct used to power any type of vehicle (land, sea, air, space), without limitation. Thus, as used herein, the term “fuel” explicitly encompasses, without limitation: petroleum based fuels such as gasoline, diesel, kerosene, jet fuel, benzene, naphtha, fuel oil, bunker oil, marine fuel, residual fuel, natural gas, methane, propane, and the like; fuel additives such as methyl-tertbutyl ether (MTBE) and tetraethyl lead (TEL); biomass-derived fuels, such as methanol, ethanol E-85, and bio-diesel; combustible natural fuels such as biomass, wood, and coal; compressed hydrogen and oxygen to be used in fuel cells or spacecraft; and solid rocket fuels such as ammonium perchlorate-based fuels (generally a combination of ammonium perchlorate and aluminum powder dispersed in a polymeric binder such as polybutadiene-acrylonitrile copolymer or hydroxyl-terminated polybutadiene.)

The term “shipper” denotes any organization or individual (without limitation) that engages a “carrier” to move goods from an origin to a destination.

The term “intermodal movement” or “intermodal shipment” denotes a movement of goods that utilizes more than one transportation vehicle or more than one mode of transportation (or both). For example, an intermodal shipment might be a movement of goods that uses a small van to transfer the goods to a transfer point where they are loaded onto a large semi-tractor trailer truck to complete the shipment. An intermodal shipment also includes shipments in which the goods to be transferred travel via at least two different types of vehicles (e.g., truck to rail to truck, or truck to air to rail to truck to bicycle courier, etc.). An intermodal shipment encompasses any combination of vehicles and any combination of terrain.

The term “drayage” or “dray” denotes the portion(s) of an intermodal movement that requires over-the-road transportation for delivery to seaports, airports, rail hubs, space ports, etc., to complete an intermodal movement. A drayage typically occurs at the beginning and at the end of an intermodal movement because ships, airplanes, trains, etc. cannot deliver to every destination due to a variety of mechanical restrictions with each form of transportation.

The terms “real-time” or “near real-time” mean systems or databases that update information at the same rate (or near the same rate) as they receive data, enabling them to direct or control a process such as assigning the asking price for a given volume of fuel, at a given period in time, in a given location.

The process is described with reference to flowcharts and/or diagrams that illustrate methods, associated apparatus or systems, and computer programs that implement the required (and optional) steps of the process. Each block as shown in the various flowcharts, and combinations of blocks in the flowcharts, can be implemented by computer program instructions. Such computer program instructions can be loaded onto a general-purpose computer, special purpose computer, or other programmable data processing device to produce a machine, such that the instructions that execute on the computer or other programmable data processing apparatus defines a machine that implements the functions specified in the flowcharts. The computer program instructions can also be stored in a computer-readable memory that directs a computer or other programmable data processing device to function in a particular manner, such that the instructions stored in the computer-readable memory that directs a computer or other programmable data processing device to function in a particular manner, such that the instructions stored in the computer-readable memory produce an article of manufacture including an instruction set that implements the function specified in the flowcharts or diagrams. The computer program instructions may also be loaded onto a computer or other programmable data processing apparatus to cause a series of operational steps to be performed on the computer or other programmable apparatus to produce a computer-implemented process such that the instructions which execute on the computer or other programmable apparatus implement the functions specified in the flowcharts or diagrams.

It will be understood that blocks of the flowcharts support combinations of systems for performing the specific functions, combinations of steps for performing the specified functions, and program instructions for performing the specified functions. Each block of the flowcharts or diagrams, and combinations of blocks in the flowcharts or diagrams can optionally be implemented by special-purpose, hardware-based computer systems that perform the specified functions or steps, or combinations of special-purpose hardware and computer (software) instructions executed on a general purpose computer.

The process itself can be implemented using any computer programming language, now known or developed in the future. Likewise, various computers and/or processors may be used to carry out the present process in the future. Likewise, various computers and/or processors may be used to carry out the process without being limited to those described herein. The present process can be implemented on conventional desktop computers, such as “IBM’-brand or IBM compatible or “APPLE”-brand or “MACINTOSH”-brand personal computers, utilizing suitable operating systems (e.g. “WINDOWS”-brand operating system, Linux, and the like). (“IBM” is a registered trademark of International Business Machines Corporation, “APPLE” is a registered trademark of Apple, Inc., “MACINTOSH” was once a registered trademark of Apple, Inc. for personal computers, but is now an unregistered mark, “WINDOWS” is a registered trademark of Microsoft Corporation.) The present process can also be implemented using other types of computers and/or processors, including, but not limited to, mainframe computers, parallel computer arrays, and the like.

The process disclosed herein is an innovative shipper-based fuel program that enables shippers to manage and take control of their fuel-related transportation costs when utilizing intermodal movements. It is based on the concept that that shippers pay for fuel costs, not carriers. Therefore, shippers (not carriers) should control fuel-provisioning programs. The crux of the present process is that shippers, not carriers, control and manage their fuel costs when shipping their goods by common carrier. In short, fuel logistics are placed in the hands of those who bear the economic impact of high fuel prices and fuel price volatility, namely shippers, not carriers.

As noted earlier, the economic impact of high fuel costs for shippers is significant. As Table 1 indicates, the diesel fuel bill for the U.S. trucking industry increased from more than $67 billion in 2004 to more than $84 billion in 2009. Further, Table 1 shows that fuel surcharges paid by shippers increased at an even greater pace than the price of the fuel iteslf. A similar pattern is exhibited by fuel spending and fuel surcharges applied to rail freight movements as well. The long-term trend is clearly pointing in the direction of ever increasing fuel prices for not just the trucking industry, but the intermodal shipping industry as well. This includes all of the trucking industry, the rail industry, the marine industry, and the air industry.

TABLE 1
Diesel Fuel Spending & Fuel Surcharges For Truck & Rail

| | 2004 | 2009 |
|---|---|---|
| On-Highway Diesel Fuel | $67,122,432,112 | $84,140,193,984 |
| Spending - Trucking | | |
| Truck Fuel Surcharges paid by | $22,572,145,312 | $43,162,826,784 |
| Shippers | | |
| Diesel Fuel Spending - Rail | $4,740,912,000 | $5,822,208,000 |
| Rail Fuel Surcharges paid by | $1,040,350,000 | $2,600,875,000 |
| Shippers | | |

Data sources include the Department of Energy's Energy Information Administration and the Surface Transportation Board.

These high fuel surcharges impact both shippers' cost of moving goods to market, as well as shippers' bottom-line financial results. Fuel surcharges are a significant cost for shippers. However, short of operating their own intermodal delivery fleets, it is a cost that shippers can neither manage, nor influence, under the present surcharge regime. Under the current industry standard, carriers implement their own fuel surcharge programs. The financial results of the carriers' customers (that is, the shippers) are given little or no consideration when carriers formulate their fuel surcharge programs for intermodal movements.

The present process changes this paradigm and enables shippers to reduce their cost of moving products to market and to take control of their fuel-related expenses when using a number of different modes for transporting their goods, e.g. intermodal movements. The present process accomplishes this by eliminating the conventional carrier-based fuel surcharge program and replacing it with an innovative, computer-implemented, shipper-based fuel management process. The process thus puts the information of each movement (distanced travel during each mode, travel time of each mode, pick-up and drop-off location of goods for each mode, mode of transportation, market fuel cost for each mode, drayage movements at the beginning and end of each intermodal movement, etc.) in the hands of the shipper and creates the ability to reduce the shippers' go-to-market costs while still achieving the benefits of intermodal movements.

Control of this knowledge, and therefore the ability to reduce the associated expenses, is critical for shippers to lower their fuel-related expenses, and thereby increase their profits. Having the shippers take control of these expenses does not impact the actual market price for fuel; neither shippers nor carriers have the power to alter market prices for fuel. However, having shippers (rather than carriers) managing and understanding their fuel costs significantly lowers the actual costs that a shipper pays to move its goods to market. This outcome is due to the fact that shippers have an inherent and powerful motivation to lower fuel costs: high fuel costs negatively impact shippers' revenues. In stark contrast, carriers treat fuel costs as a pass-through expense that is ultimately paid back to them by the shippers. Thus carriers do not have the same economic motivation that shippers do to keep fuel costs as low as possible. The reduction in total costs incurred by shippers in using the conventional fuel surcharge programs do not accurately represent the shippers' true cost of fuel for moving products to market. As explained below, fuel surcharge programs are artificially slanted to favor carriers' revenues, rather than shippers' revenues, especially when dealing with intermodal movements.

### The Fuel Surcharge: a Carrier-Based Program:

The current, industry-standard rail intermodal fuel surcharge program focuses on the carrier's ability to recover from its customers (the shippers) the excess cost of fuel above and beyond a price included in the carrier's quoted transportation rates. Inherit distortions often occur within the carrier's quoted transportation rates. The root cause of these distortions is because many rail intermodal carriers utilize truckload or “over-the-road” fuel costs to quote their transportation rates, even though the actual movement of freight is split between traveling over-the-road and on-the-rail. In addition to the distortion created by the split road-rail miles, there is also a difference between fuel types, fuel costs, and fuel taxes that are not accounted for with the typical intermodal fuel surcharge programs.

The conventional process for a typical intermodal fuel surcharge program is as follows:

1. The carrier or the carrier's intermediary and the shipper negotiate transportation rates for freight movements. The negotiated transportation rate includes a fuel surcharge schedule.

2. The fuel surcharge is a sliding schedule that provides for an additional charge to be added to the transportation charges, based on a fuel price formula that historically does not accurately correlate to actual pricing in the fuel market.

3. The typical formula includes a base price-per-gallon that is included in the transportation charge and compares it to an “over the road” industry-wide index to determine the “cost of fuel” surcharge that is added to the freight transportation bill of each intermodal carrier (rail, truck, air, marine, etc.).

Table 2 shows a typical calculation of conventional fuel surcharge as applied to an intermodal shipment taking place during the 4^{th} quarter of 2011:

TABLE 2
Fuel Surcharge Example
Intermodal Percent of Revenue Fuel Surcharge

| | | Average Highway Diesel Fuel | |
|---|---|---|---|
| Effective | Fuel Surcharge | Price | Price |
| Period | Percentage | (per gallon) | as of |
| Dec. 14, 2011-Dec. | 34.5% | $3.931 | Dec. 05, 2011 |
| 20, 2011 | | | |
| Dec. 07, 2011-Dec. | 35.0% | $3.964 | Nov. 28, 2011 |
| 13, 2011 | | | |
| Nov. 30, 2011-Dec. | 35.5% | $4.010 | Nov. 21, 2011 |
| 06, 2011 | | | |
| Nov. 23, 2011-Nov. | 35.0% | $3.987 | Nov. 14, 2011 |
| 29, 2011 | | | |
| Nov. 16, 2011-Nov. | 34.0% | $3.887 | Nov. 07, 2011 |
| 22, 2011 | | | |
| Nov. 09, 2011-Nov. | 34.0% | $3.892 | Oct. 31, 2011 |
| 15, 2011 | | | |
| Nov. 02, 2011-Nov. | 33.0% | $3.825 | Oct. 24, 2011 |
| 08, 2011 | | | |
| Oct. 26, 2011-Nov. | 33.0% | $3.801 | Oct. 17, 2011 |
| 01, 2011 | | | |
| Oct. 19, 2011-Oct. | 32.0% | $3.721 | Oct. 10, 2011 |
| 25, 2011 | | | |
| Oct. 12, 2011-Oct. | 32.0% | $3.749 | Oct. 03, 2011 |
| 19, 2011 | | | |
| Oct. 05, 2011-Oct. | 32.5% | $3.786 | Sep. 26, 2011 |
| 11, 2011 | | | |
| Sep. 28, 2011-Oct. | 33.0% | $3.833 | Sep. 19, 2011 |
| 04, 2011 | | | |
| Sep. 21, 2011-Sep. | 33.5% | $3.862 | Sep. 12, 2011 |
| 27, 2011 | | | |

The fuel surcharge example in Table 2, which depicts the BNSF Railway published intermodal fuel surcharge program is representative of conventional industry practice in the United States. (The BNSF Railway, 2650 Lou Menk Drive, Ft. Worth, Tex., was formed on Dec. 31, 1996, by the merger of the Atchison, Topeka & Santa Fe Railway and the Burlington Northern Railroad. This merger was the culmination of approximately 390 separate mergers and acquisitions over the course of 160 years. Since Nov. 3, 2009, BNSF Railway has been a wholly owned subsidiary of Berkshire Hathaway, Inc. It is the second largest freight rail network in North America, surpassed only by the Union Pacific Railroad. The BNSF Intermodal Fuel Surcharge Program can be found online at http://www.bnsf.com/customers/fuel-surcharge/.)

There are several distinct flaws with this fuel surcharge methodology for intermodal movements:

First, it is an industry-average pass-through set by the carrier. Whether the shipper is large and “purchases” a high volume of fuel to move its products to market or the shipper is small and “purchases” a relatively small amount of fuel, the surcharge is the same. There is no ability to leverage a shipper's volume to obtain favorable fuel pricing. Meanwhile, under the current fuel-surcharge system, carriers are able to leverage their large volume to obtain favorable fuel pricing and do not pass that pricing on to shippers.

Second, the shipper has no ability to influence short- or long-term prices. Shippers cannot negotiate better fuel pricing, cannot determine where to fuel, cannot choose when to fuel, cannot choose from whom to purchase fuel, and cannot create a long-term strategy to manage (i.e., hedge) fuel costs and provisioning.

Third, the fuel surcharge system utilized today is typically based on full retail, at-the-pump pricing for fuel. Here is where the fuel surcharge system for intermodal movements is heavily slanted in favor of intermodal carriers, to the detriment of shippers. The retail, at-the-pump price is nowhere near the best price available for fuel in the marketplace. In fact, retail, at-the-pump prices are the highest prices paid for fuel in the marketplace and are typically not even a consideration of fueling for a number of intermodal carriers including marine, rail, or air carriers. Sophisticated carriers (including truckload carriers, in addition to other intermodal carriers including marine, rail, and air carriers) make every effort not to pay full-retail, at-the-pump prices for fuel. When intermodal carriers pay for fuel efficiently (i.e. at prices significantly under the full retail price), the carrier makes an additional profit on the fuel surcharge because the fuel surcharge is based on the retail price of fuel, while the carrier actually pays far less for the fuel needed to accomplish any given freight movement. Alternatively, when a carrier does not buy fuel efficiently (e.g., a major intermodal carrier not leveraging its volume to receive fuel at a less-then-retail price level), it is the seller of the fuel who makes extra profit. In both instances, the shipper is subsidizing artificially high fuel costs with little logical grounding for the shipper's own expense.

Fourth, the intermodal fuel surcharge system implies that all consumed gallons will have the same tax structure as “over-the-highway” diesel. Because a significant amount of the miles traveled by a rail intermodal movement are traveled on the railroad, this is not an accurate representation of the fuel economics. In fact, the rail-related gallons are exempt from federal diesel excise road tax as well as state diesel excise road taxes. While there are select fuel taxes related to rail fuel consumption, it is significantly different from the road taxes which are charged as part of the typical intermodal fuel surcharge program.

Fifth, the Surface Transportation Board (SBT), which is the regulatory body that oversees the rail industry, has come out on record as being opposed to the existing fuel surcharge methodology. In fact, a 2007 ruling by the SBT stated that it is:
an unreasonable practice for railroads to compute fuel surcharges in a manner that does not correlate with the actual fuel costs for specific rail shipments . . . * * * in its decision, the SBT prohibits the assessment of fuel surcharges based on a percentage calculation of the base rate charged to freight railroad customers.

### STB Decision “Rail Fuel Surcharges,” STB Ex Parte No. 661 (Sub-No. 0), Jan. 25, 2007.

At the same time, both the industry and the SBT have stated that the means to accurately measure fuel costs for intermodal movements does not exist and it remains a strategic objective of the regulators to identify a method. Also, because intermodal traffic, specifically TOFC (Trailer-on-Flat Car) and COFC (Container-on-Flat Car) are exempt business activities from SBT rulings, the rail industry has not made the changes (elimination of the percentage based fuel surcharge) that the SBT has included in their rulings.

The response to this lack of change in intermodal fuel surcharges by industry and regulators has been two-fold. First, groups of shippers have filed suit against the rail industry charging that the current fuel surcharge methodology is unreasonable. (Several cases are still pending as of December 2011.) In addition, the SBT convened a public hearing, in February 2011, to review whether to eliminate the TOFC/COFC (among other) anti-trust exemptions (as of December 2011, no decision has been announced). One of the reasons stated for reviewing these exemptions has been the unreasonableness of fuel surcharge practices.

The present process addresses these regulatory concerns and the basic economic flaws and inefficiencies in intermodal movements. It puts the control of the intermodal movement information and fuel marketplace information into the hands of the party that bears the economic burden of fuel costs—the shippers—and allows shippers to reimburse intermodal carriers accurately and fairly for the actual cost of fuel.

### The “Breakthrough” Fuel Solution to Intermodal Movement Fuel Costs:

The present process is an innovative, computer implemented, shipper-based fuel management program that address the inherent flaws of today's carrier-based fuel programs. The process provides a host of significant advantages for shippers that utilize intermodal movements for their goods:

A principal advantage of the process is that it reduces the fuel-related costs of moving products to market while using multiple modes of transportation by replacing an artificial fuel surcharge subsidy with an actual fuel cost that can be managed by the shipper.

Another advantage of the process is that it enables the shipper to take control and understand the real, market-based, fuel-related costs of moving its goods to market via intermodal movements. This encourages shippers to take long-term positions with respect to fuel acquisitions and consumption. With this understanding, the shipper can develop a long-term fuel strategy, be it by simply tracking the market fluctuation of fuel costs more closely, establishing a fixed average price of fuel (using future contracts) for intermodal movements, or something in between. Unique to intermodal movements (as opposed to using a single mode of transportation), shippers will also be able to collect supplemental information about the benefits of each individual mode of transportation to ship their goods.

Moreover, the advantages of the present process are not solely for the shippers. The present process also offers intermodal carriers an innovative fuel program that can convert one of their most volatile operating expenses into a fixed cost. This advantage is particularly true (and valuable) for the rail industry, which has experienced legal challenges to the calculating of fuel surcharges since early 2006. As noted above, the SBT has been seeking accurate and fair methodologies to solve the dilemma of ‘untraceable’ fuel costs for intermodal/rail carriers for years.

There are three basic components to the present process that can be used individually or in combination with each other: the Intermodal Fuel Recovery Process, the Intermodal Fuel Tracking System and Strategic Fuel Programs. The key characteristics of each of these components are described below.

### Intermodal Fuel Recovery Process:

The Intermodal Fuel Recovery Process enables shippers to receive fuel information along lanes (roads, airways, railways, etc.) that carriers use for intermodal movements, allowing shippers to receive real-time information and support regarding fuel information during the intermodal movements they contract. This important shift in thinking and acting—shippers receiving and using fuel information for payments to carriers—provides the foundation for the present process and creates the opportunity for reducing the cost of moving products to market.

The Intermodal Fuel Recovery Process creates the opportunity for fuel cost savings based on several important principles of the present process that do not exist with current intermodal fuel surcharge programs:

First, shippers should never pay more for fuel than the actual cost of the fuel required to move their freight from origin to destination when using two or more modes of transportation. Thus, in the present process, the shipper pays based on the actual fuel cost associated with a freight movement. This is in stark contrast to conventional truckload fuel surcharge protocols, where the shipper pays based on the full-retail Department of Energy index that is in effect for the entire week (or even month) of the shipment. Both the undiscounted nature of the index and the reporting delay can cause a significant gap between the actual price a carrier pays for fuel and the inflated price the shipper pays to the carrier. Perhaps the greatest distortion comes into play, however, when the rest of the intermodal industry uses these truckload fuel surcharge protocols (or slightly modified versions) to charge for their own fuel surcharge programs when there are no ties to that mode's actual cost for fuel. For example, rail carriers charging their clients for fuel using a truckload fuel surcharge schedule based on the Department of Energy index for over-the-road retail fuel costs; this type of rail fuel surcharge system is totally divorced from the real market prices for over-the-rails diesel.

Second, shippers should benefit from the volume leverage that they provide to carriers. Thus, in the present process, the price for fuel is based on the market price (or as close to market price as possible that can be received, depending on the mode of transportation) as the shipper is able to weigh the leverage of their volume through the Intermodal Fuel Recovery Process in addition to the volume of other shippers utilizing the Intermodal Fuel Recovery Process. This allows for the Intermodal Fuel Recovery Process to acquire discounted fuel prices based on the sum of all intermodal shipping volume from shippers who utilize the Intermodal Fuel Recovery System. Again, this is in stark contrast to conventional fuel surcharge protocols where the price for fuel is based on the full retail, at-the-pump prices, regardless of whether the shipper is making a one-time shipment or thousands of shipments per year. Under the current fuel surcharge regime, when a shipper is making thousands of shipments per year, it is the intermodal carrier that leverages the shipper's volume to obtain fuel price discounts (and the benefit of those discounts extends to the intermodal carriers, not the shippers who decide to ship the intermodal movement). In effect, rather than the shipper receiving a volume discount, a shipper's high freight volume creates an even larger price gap between the amount the intermodal carrier pays for fuel versus the inflated fuel price the intermodal carrier charges to the shipper. This is another economic distortion caused by the conventional fuel surcharge protocols that hides the true benefits of shipping via intermodal carriers.

Third, the shippers' ability to secure volume fuel discounts for their intermodal movements should create more carrier options for the shipper, rather than fewer carrier options. In the present process, all carriers moving freight for the shipper benefit from buying fuel on the shipper's behalf. Smaller carriers are able to provide more competitive pricing as compared to larger carriers because smaller carriers are able to compete on fuel costs. This is especially true when dealing with the drayage portion of the intermodal movement because semi-truck carriers that work in a hyper-competitive local or regional market typically handle the drayage. Both large and small carriers purchase fuel for the same price on behalf of the shipper. This gives shippers a large selection of carriers to choose from when deciding which company should handle their intermodal shipments.

These principles provide shippers with important benefits in support of their transportation programs. These principles both lower the total cost of moving freight to market and create additional capacity options for the shipper when utilizing intermodal travel.

Implementing the Intermodal Fuel Recovery Process and obtaining these benefits is easy for the shipper. The present process proceeds as follows:

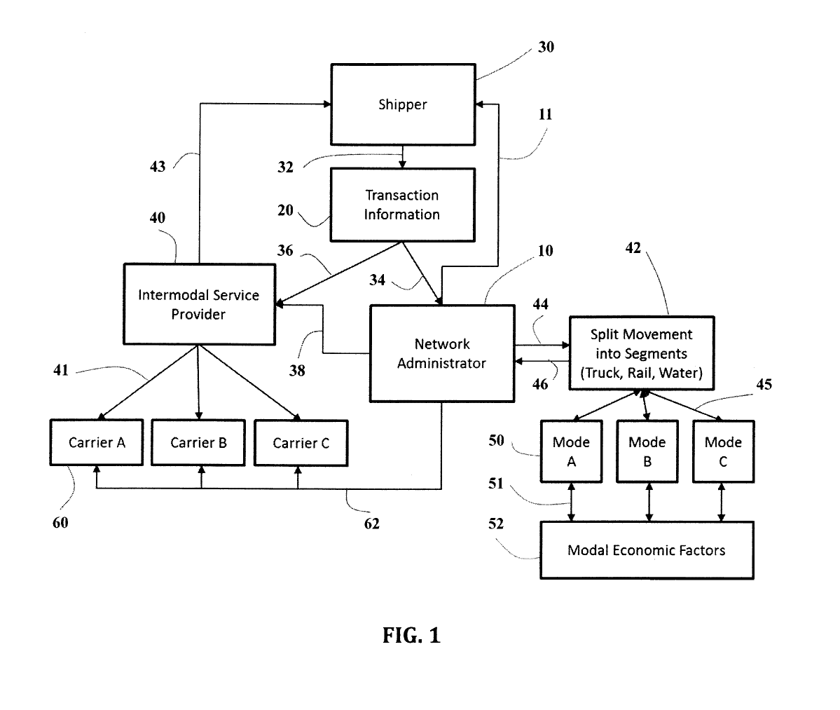

Referring to FIG. 1, the Shipper 30 designates which intermodal carriers 60 it will be utilizing for its intermodal movement. The carrier 60 are typically, although not always, chosen via an intermediary, designated the Intermodal Service Provider 40 in FIG. 1. At this point, the Network Administrator 10 coordinates an intermodal implementation with the carrier, which explains the Intermodal Fuel Recovery Process and can provide training and education materials, contact information and access to a version of the Intermodal Fuel Tracking System.

The shipper then designates the shipment that will be carried across multiple modes of transportation (Split Movement) 42 to reach its final destination. The shipper also supplies a copy of the Transaction Information 20 to the Network Administrator 10, preferably electronically using any communication means now known or developed in the future. As noted earlier, the transaction information includes the particulars of the shipment being made, such as (but not limited to) origin, destination, goods being shipped, weight of goods, pick-up-date, deliver-by date, any other special handling instructions or conditions, etc.

Each of the intermodal carriers 60 move the freight for the shipper (typically in a “drayage-rail movement-drayage” pattern). Each carrier along each route or leg of the shipment submits to the Network Administration 10 when and where the goods where picked up and dropped off for each leg of the shipment via communication link 62. The “pick up” and “drop off” dates and times are sent to the Network Administrator by any communication mechanism now known or developed in the future, preferably electronic via a global computer network. The Network Administrator then uses the Intermodal Fuel Recovery Process to determine fuel costs along each intermodal carrier's individual leg of the intermodal movement. The Network Administrator 10 provides this information to both the Shipper 30 and the Intermodal Service Provider 40 via any communication mechanism.

The information regarding the Intermodal Fuel costs are then used for billing purposes regarding the exact intermodal movement. The Network Administrator may also provide shippers and carriers with detailed reports. These reports enable shippers and carriers to gain a better understanding of their fuel logistics.

FIG. 1 is a flow chart presenting a model depicting intermodal movement as it is handled within the Intermodal Fuel Recovery System. At the heart of the method is the Network Administrator 10. Via connections 11, 32, 34, 38, 43, 44, and 46, the Network Administrator shares Transaction Information 20 with one or more Shippers 30 and Intermodal Service Providers 40. The Intermodal Service Provider 40 itself may be an integrated intermodal carrier, or the Intermodal Service Provider may be an intermediary between the Network Administrator 10, the Shipper 30, and the actual carriers 60 (Carrier A, Carrier B, Carrier C, etc.) that will accomplish one or more legs of the intermodal shipment.

To start, the Shipper 30 designates the Transaction Information 20 and provides this to the Network Administrator via communications link 32 and 34. The Transaction Information, may be as simple or as detailed as the Shipper wishes it to be. At a bare minimum, the Transaction Information provided by the Shipper would be the origin and destination of the shipment. In practice, however, the Transaction Information preferably includes a great deal more information, including one or more of the following: the mode of transportation for each leg of the shipment; distance traveled for each leg of the shipment; pick-up and drop-off locations for each leg of the shipment; the contemporaneous market cost of fuel for each leg of the shipment at or near the pick-up or drop-off locations; the type of fuel for each leg of the shipment; the actual amount of fuel consumed in each leg of the shipment; and the location where fuel for each leg of the shipment was acquired.

Modal economic factors 52, also referred to as carrier fuel purchase information, 52, for each transportation mode 50 (truck, rail, etc.) (Mode A, Mode B, Mode C, etc.) of transportation for the shipment is also provided to the Network Administrator once the entire split movement 42 (i.e., the full route of the shipment and the modes utilized) is known. This information may include data such as actual price paid for fuel for each leg, amount of fuel purchased for each leg, a shipper identifier, a carrier identifier for each leg, a shipment identifier, a shipment weight identifier, an origin identifier, a destination identifier, a route identifier, a sender identifier, a recipient identifier, a date identifier, a time identifier, a location identifier, a fuel merchant identifier, a driver identifier, a vehicle identifier, a vehicle miles-per-gallon identifier, a vehicle odometer identifier, and/or a vehicle weight identifier (or any combination of these). The foregoing list is exemplary, not exclusive. This information is provided to the Network Administrator via connections 51, 45, and 46, and (as noted above) is ultimately provided to Shippers 30 by the Network Administrator. The Network Administrator then uses the Transaction Information (including the Modal Economic Factors) to calculate a fuel payment to each carrier involved in the intermodal shipment.

The Intermodal Service Provider 40 manages the shipment through each leg by interfacing with the individual Carriers 60, via communications links 41. Likewise, the Network Administrator 10 is also in communication with the individual Carriers 60 via link 62. Likewise, the Intermodal Service Provider 40 is also in communication with the Shipper 30 via link 43. In this fashion, all of the logistical details of a shipment (pick-up and drop-off points, times, etc.), as well as all of the Modal Economic Factors and other Transaction Information (fuel types, amounts, prices, etc.) are known to the Network Administrator and ultimately communicated to the Shipper.

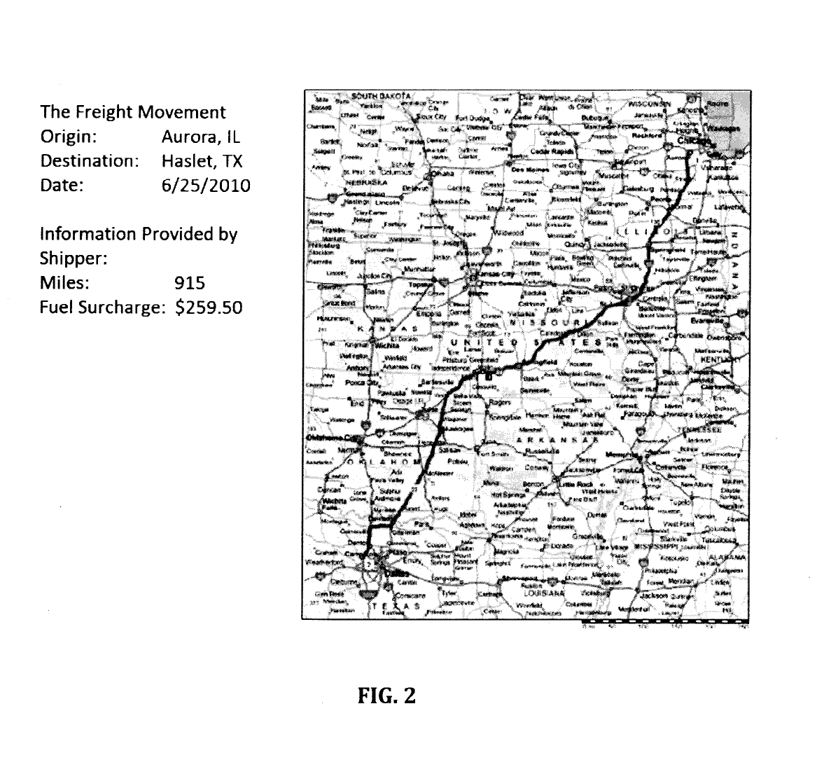

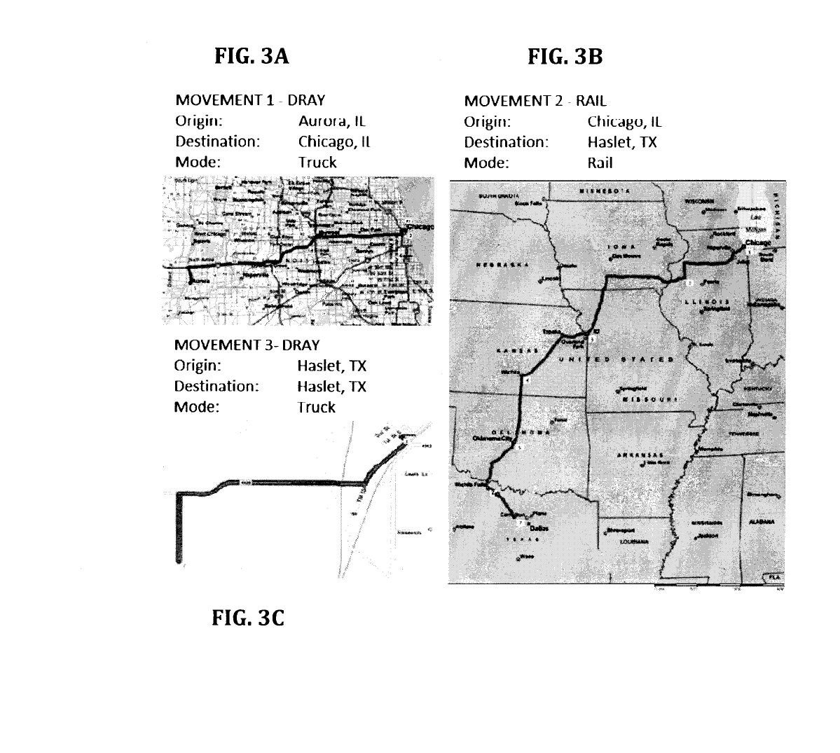

FIG. 2 is a map and associated distance and fuel surcharge information for an exemplary conventional shipment of freight from Aurora, Ill., to Hazlet, Tex. on Jun. 24, 2010. In contrast, FIGS. 3A, 3B, and 3C are maps and associated distances and charges for the same shipment as depicted in FIG. 2, using the present intermodal fuel cost process. FIG. 3A depicts the drayage by truck from Aurora, Ill. to a Chicago, Ill. rail terminal. FIG. 3B depicts the rail shipment from Chicago to the Hazlet, Tex. rail yard. FIG. 3C depicts the drayage by truck to the final destination in Hazlet. Table 3 shows the economics for each leg of the intermodal shipment depicted in FIGS. 3A, 3B, and 3C:

TABLE 3
True Fuel Consumption and Cost for Intermodal Shipment
BREAKTHROUGH ® FUEL RECOVERY ECONOMICS

| MOVEMENT | FIG. 3A | FIG. 3B | FIG. 3C | TOTAL |
|---|---|---|---|---|
| MODE | Truck | Rail | Truck | Intermodal |
| DISTANCE (miles) | 38 | 995 | 10 | 1,043 |
| FUEL EFFICIENCY | 6.0 | 15.5 | 6.0 | 14.45 |
| (MPG) | | | | |
| GALLONS | 6.33 | 64.19 | 1.66 | 72.18 |
| FUEL COST/GALLON | $3.066 | $2.191 | $2.655 | $2.278 |
| TOTAL FUEL COST | $19.40 | $140.64 | $4.41 | $164.45 |
| CARBON EMISSIONS | 0.066 | 0.667 | 0.017 | 0.75 |
| (MT) | | | | |

A comparison of the two methods—the traditional intermodal fuel surcharge method shown in FIG. 2 and the Intermodal Fuel Recovery process depicted in Table 3 and FIGS. 3A, 3B, and 3C is depicted in Table 4.

TABLE 4
Comparison of Fuel- Cost Computation Economics
INTERMODAL MOVEMENT ECONOMIC SUMMARY

| | | Traditional Fuel Surcharge |
|---|---|---|
| | Present Process | Methodology |
| MOVEMENT MILES | 1,043 | 915 |
| GALLONS | 72.18 | Unavailable/unknown |
| FUEL COST/GALLON | $2.278 | Unavailable/unknown |
| TOTAL FUEL COST | $164.45 | Unavailable/unknown |
| PAYMENT TO | $164.45 | $259.50 |
| INTERMODAL | | |
| PROVIDER FOR FUEL | | |
| CARBON EMISSIONS | 0.75 | Unavailable |
| (MT) | | |

An important aspect shown by Table 4 is that under both the conventional fuel surcharge protocol for intermodal movements and the present process's Intermodal Fuel Recovery Process, the carrier is paid the same amount of money for the carrier's actual services to move the freight. The key difference is that any payments by the shipper to the carrier for fuel under the present process are directly related to the actual fuel consumption and costs needed to complete the shipment.

In addition, the present process provides full transparency of each of the key elements in the Intermodal Fuel transaction: the actual distance traveled; the actual fuel gallons required for the movement; the discounted market fuel for the movement; the actual fuel cost associated with the freight movement and; the movement's carbon emissions. Under the traditional fuel surcharge method, these critical factors are unavailable to the shipper. (From the carriers' perspective, this information is kept confidential for a very good reason: shippers would balk and demand refunds if they knew the true extent of the unnecessary fees they are paying pursuant to the fuel surcharge protocols.)

### The Intermodal Fuel Tracking System:

The Intermodal Fuel Recovery Process requires a Network Administrator to compile the data associated with each intermodal movement made by an intermodal carrier while transporting a shipment across multiple modes of transportation. Preferably, the Network Administrator—using a set of protocols designated herein as the Intermodal Fuel Tracking System—does this. The Intermodal Fuel Tracking System is able to tabulate the actual fuel prices of fuel locations along the travel lanes of each intermodal carrier and is capable of computing the average costs of fuel along each travelled lane for each mode of transportation involved in an intermodal movement. The Intermodal Fuel Tracking System also provides the capability to audit the Intermodal Fuel Recovery Process and its transactions. In the preferred embodiment, access to the Intermodal Fuel Tracking System is provided equally to all shippers and carriers participating in the Intermodal Fuel Recovery Process. In essence, the Intermodal Fuel Tracking System enables shippers to implement and manage many aspects of their fuel program.

Driving the Intermodal Fuel Tracking System is a computer-implemented program that manages and calculates all fuel pricing and costs across transportation lanes used by intermodal carriers (railways for intermodal rail carriers, highways for intermodal truckload carriers, seaways for intermodal marine carriers, etc.). The Intermodal Fuel Tracking System also manages information regarding possible fueling locations accessible to different modes of transportation (as airplanes do not typically fuel at the same station as trains or semi-trucks, for example). The Intermodal Fuel Tracking System is also capable of handling financial aspects of intermodal shipping transactions including fuel pricing, freight-fuel matching, carrier fuel credit management, and shipper fuel invoicing. The Intermodal Fuel Tracking System provides the ability for comprehensive management reporting to understand, manage, and audit fuel transactions and costs on behalf of the shipper and each intermodal carrier or the intermediary.

There are four components of the Intermodal Fuel Tracking System:

The Electronic Communication Module (ECM). The ECM provides the electronic communication interface, through EDI or XML transactions (or any other communication protocol), between participants in the Intermodal Fuel Recovery Process and its partners. These transactions include shipper load tenders, fuel provider cost and price information, and transaction mode information.

The Fuel Transaction Engine. The fuel transaction engine manages and controls all fuel transactions received using the Intermodal Fuel Recovery Process, captures and applies all cost and price information along the intermodal movement and is capable of controlling all settlements for both shippers and carriers.

The Intermodal Shipper Web Interface (the “Shipper Interface”). Shippers will have access to the Intermodal Fuel Tracking System through a secure interface provided by the Network Administrator. The Shipper Interface provides shippers with key functionality to manage their individual fuel program, including the ability: to access all freight and fuel transactions across all modes of transportation; to control and manage all transactions, to access and to authorize all settlements, and to generate comprehensive management and audit reports.

The Intermodal Carrier Interface (the “Carrier Interface”). Likewise, carriers will have access to the Intermodal Fuel Tracking System through a secure interface that provides intermodal carriers with operational, transactional and reporting capabilities regarding their movements along specific modes of transportation. The transaction capabilities include the ability to access fuel and freight transactions as well as settlements. Additional capabilities include comprehensive management reporting and audit capabilities.

### Strategic Fuel Programs:

The third component of the present process is an added benefit to taking advantage of the Intermodal Fuel Recovery Process and Intermodal Fuel Tracking System: Strategic Fuel Programs. Once a shipper takes control of its fuel-related programs by moving off of an intermodal fuel surcharge, the shipper has the opportunity to develop a long-term intermodal fueling strategy.

Shippers transacting their fuel purchases by using the Intermodal Fuel Recovery Process have the ability to develop long-term fuel strategies to help reduce financial volatility and to manage fuel supply across multiple modes of transportation (not limited to, but including planes, trains, space, marine, over-the-road, etc). Custom programs are developed in alignment with the shipper's corporate culture and fuel requirements.

A unique aspect of the strategic fuel program is its capacity to be integrated within the Intermodal Fuel Tracking System itself. Specifically, once a shipper takes control and manages its fuel costs (rather than being at the whim of a fuel surcharge schedule), shippers can develop and implement a strategic fuel program to influence and control the long-term price volatility of fuel. These strategic programs—for example, price hedges, caps, collars, etc—can be integrated into the Intermodal Fuel Tracking System so that the benefit of the price hedging programs can be linked to fuel purchases made on behalf of the shipper across a variety of transportation modes.

### Advantages of Present Process:

There are several benefits for shippers that can lower the cost of moving their products to market through intermodal carriers by controlling fuel costs:

The cost of incremental fuel prices can be managed and leveraged to reduce actual fuel costs. Instead of basing this fuel cost on a nation fuel average that is based on the retail price of over-the-road carriers and then spread across all other modes of transportation (most infamously done in the intermodal rail shipping industry), shippers will be able to utilize a true cost of fuel for reimbursing carriers of all modes accurately to the costs these carriers occur when transporting the shipper's goods.

In addition, freight costs actually paid will reflect the true cost of getting the product to market via multiple modes of transportation, without having the volatility (and gross inaccuracies) of intermodal fuel costs being improperly factored into the cost. Thus, the present process provides shippers an opportunity to determine the most cost-efficient modes of transportation for their shipments and then to negotiate with carriers or their intermediaries for freight costs using knowledge gained through the Intermodal Fuel Recovery Process and the Intermodal Fuel Tracking System.

Specifically in the rail intermodal industry, shippers will (for the first time) have access to accurate and complete information regarding their fuel behavior and costs. This will enable a more competitive transportation marketplace and, by removing economic distortions from intermodal movements, will make railroad transportation more competitive.

In the end, by taking control of fuel used to move their freight over multiple modes of transportation, shippers can leverage their volume and knowledge to reduce the price of fuel being used to support their operations and facilities while also reducing carbon emissions through the use of multiple modes of transportation.

What is claimed is:

1. A computer-implemented method for managing intermodal fuel costs, comprising:
(a) receiving, compiling, and storing transaction information at a Network Administrator loaded on a computer, the transaction information being associated with: at least one shipper who has arranged for an intermodal shipment of goods from an origin to a destination, and at least one carrier that has agreed to complete at least one leg of the intermodal shipment, wherein the transaction information comprises:
mode of transportation for each leg of the shipment;
distance traveled for each leg of the shipment;
pick-up and drop-off locations for each leg of the shipment; and
real-time or near real-time market cost of fuel for each leg of the shipment at or near the pick-up or drop-off locations;
(b) transmitting the transaction information from step (a) from the Network Administrator to the shipper; and
(c) calculating a fuel payment to the at least one carrier based upon the transaction information transmitted in step (b), wherein the fuel payment approximates actual fuel costs incurred to complete the intermodal shipment.

2. The method of claim 1, wherein step (b) comprises transmitting the transaction information from step (a) on a non-confidential basis to all shippers having access to the Network Administrator.

3. The method of claim 1, wherein the transaction information further comprises:
type of fuel for each leg of the shipment;
fuel efficiency of each vehicle used in each leg of the shipment; and
location where fuel for each leg of the shipment was acquired.

4. The method of claim 3, wherein step (b) comprises transmitting the transaction information from step (a) on a non-confidential basis to all shippers having access to the Network Administrator.

5. The method of claim 3, further comprising transmitting to the computer on which the Network Administrator is loaded carrier fuel purchase information comprising actual price paid for fuel and amount of fuel purchased by the at least one carrier to complete each leg of the intermodal shipment.

6. The method of claim 5, wherein the carrier fuel purchase information further comprises one or more identifiers selected from the group consisting of a shipper identifier, a carrier identifier, a shipment identifier, an origin identifier, a destination identifier, a route identifier, a sender identifier, a recipient identifier, a date identifier, a time identifier, a location identifier, a fuel merchant identifier, a driver identifier, a vehicle identifier, a vehicle miles-per-gallon identifier, a vehicle odometer identifier, and a vehicle weight identifier.

7. The method of claim 6, further comprising transmitting carrier fuel purchase information from the computer on which the Network Administrator is loaded to the shipper and the carrier.

8. The method of claim 3, wherein the transaction information further comprises one or more identifiers selected from the group consisting of a shipper identifier, a carrier identifier, a shipment identifier, a shipment weight identifier, a pick-up date identifier, a delivery-date identifier, an origin identifier, a destination identifier, a route identifier, a sender identifier, a recipient identifier, a date identifier, a time identifier, a location identifier, a fuel merchant identifier, a driver identifier, a vehicle identifier, a vehicle miles-per-gallon identifier, a vehicle odometer identifier, a vehicle hours identifier, and a vehicle weight identifier.

9. The method of claim 3, wherein the transaction information further includes total volume of fuel purchased by the at least one shipper over a pre-determined prior time period; and step (c) further comprises discounting the fuel payment by an amount determined according to a pre-determined schedule corresponding to the total volume of fuel purchased by the at least one shipper over the pre-determined time period.

10. A computer-implemented method for managing intermodal fuel costs, comprising:
(a) receiving, compiling, and storing transaction information at a Network Administrator loaded on a computer, the transaction information being associated with: (a) at least one shipper who has arranged for an intermodal shipment of goods from an origin to a destination; and (b) at least one carrier that has agreed to complete at least one leg of the intermodal shipment, wherein the transaction information comprises:
mode of transportation for each leg of the shipment;
distance traveled for each leg of the shipment;
pick-up and drop-off locations for each leg of the shipment; and
real-time or near real-time market cost of fuel for each leg of the shipment at or near the pick-up or drop-off locations;
type of fuel for each leg of the shipment;
fuel efficiency of each vehicle used in each leg of the shipment; and
location where fuel for each leg of the shipment was acquired;
(b) transmitting the transaction information from step (a) from the Network Administrator to the shipper; and
(c) calculating a fuel payment to the at least one carrier based upon the transaction information transmitted in step (b), wherein the fuel payment approximates actual fuel costs incurred to complete the intermodal shipment.

11. The method of claim 10, wherein step (b) comprises transmitting the transaction information from step (a) on a non-confidential basis to all shippers having access to the Network Administrator.

12. The method of claim 11, further comprising transmitting to the computer on which the Network Administrator is loaded carrier fuel purchase information comprising actual price paid for fuel and amount of fuel purchased by the at least one carrier to complete each leg of the intermodal shipment.

13. The method of claim 12, wherein the carrier fuel purchase information further comprises one or more identifiers selected from the group consisting of a shipper identifier, a carrier identifier, a shipment identifier, an origin identifier, a destination identifier, a route identifier, a sender identifier, a recipient identifier, a date identifier, a time identifier, a location identifier, a fuel merchant identifier, a driver identifier, a vehicle identifier, a vehicle miles-per-gallon identifier, a vehicle odometer identifier, and a vehicle weight identifier.

14. The method of claim 13, further comprising transmitting carrier fuel purchase information from the computer on which the Network Administrator is loaded to the shipper and the carrier.

15. The method of claim 11, wherein the transaction information further comprises one or more identifiers selected from the group consisting of a shipper identifier, a carrier identifier, a shipment identifier, a shipment weight identifier, a pick-up date identifier, a delivery-date identifier, an origin identifier, a destination identifier, a route identifier, a sender identifier, a recipient identifier, a date identifier, a time identifier, a location identifier, a fuel merchant identifier, a driver identifier, a vehicle identifier, a vehicle miles-per-gallon identifier, a vehicle odometer identifier, a vehicle hours identifier, and a vehicle weight identifier.
